(19) United States
(12) Patent Application Publication
(10) Pub. No.: US 2021/0043120 A1
(43) Pub. Date: Feb. 11, 2021

(54) DISPLAY DEVICE WITH THREE-DIMENSIONAL SIGN

(71) Applicant: DAIKAN CO.,LTD., Osaka-shi, Osaka (JP)

(72) Inventors: Osamu JINGI, Osaka (JP); Akio SAITO, Osaka (JP)

(21) Appl. No.: 16/975,988

(22) PCT Filed: Feb. 25, 2019
(86) PCT No.: PCT/JP2019/007122

§ 371 Date: Aug. 26, 2020

(30) Foreign Application Priority Data
Feb. 26, 2018 (JP) 2018-031486

(51) Int. Cl. G09F 19/12; G09F 9/35; G09F 9/33

(52) U.S. Cl. CPC G09F 19/12; G09F 9/35; G09F 9/33; G09G 3/36; G09G 2320/0613; G09G 2320/066; G09G 2320/0252; G09G 2320/028

(57) ABSTRACT

Provided is a display device with three-dimensional sign that can achieve both sign visibility and a variety of presentation effects. The display device with three-dimensional sign 1 includes: a display panel 11 that has a transparent panel 11a on a front surface and that displays an image including a still image and/or a moving image; and a control unit 3 that controls display of the image in the display panel 11, the display device further including a thick, translucent three-dimensional sign part 10 that is provided in a part of the front surface of the transparent panel 11 and formed into a shape representing a character, a graphic, or a pattern.

### TECHNICAL FIELD

The present invention relates to a display device with three-dimensional sign, which is used for, for example, an illuminated sign, an illuminated advertisement, etc. of a store name or a logo.

### BACKGROUND ART

Conventionally, a decorative light emitting device called an illuminated sign or an illuminated advertisement that brightly displays a store name or a logo has been provided. Such a decorative light emitting device diffuses light from a light source on a front panel to emit diffused light so as to brightly display a design such as a store name or a logo. The decorative light emitting device provides high visibility and beautiful signs, and thus, is used in various places, such as storefront or entrance of a brand store, for displaying a brand name.

The decorative light emitting device described above has been changed from a conventional neon sign to a recent LED sign using an LED, and is required to provide various design properties.

For example, Patent Literature 1 discloses a luminous advertisement device using a light emitting diode, the luminous advertisement device including a first display part that displays a predetermined pattern or characters using light emitting diodes of multiple colors, and a second display part that changes and displays characters by driving monochromatic (red) light emitting diodes, which are arranged in a matrix, in a bitmap format, in order to achieve reduction in cost and high-grade display.

### CITATION LIST

### Patent Literature

Patent Literature 1: JP 2000-132120 A

### SUMMARY OF THE INVENTION

### Technical Problems

However, the abovementioned luminous advertisement device merely includes the first display part and the second display part that provide different displays, and cannot achieve both sign visibility and a variety of presentation effects.

The present invention has been made in view of the above problems, and an object of the present invention is to provide a display device with three-dimensional sign that can achieve both sign visibility and a variety of presentation effects.

### Solution to Problems

The present invention provides a display device with three-dimensional sign including: a panel that displays an image including a still image and/or a moving image; and a control unit that controls display of the image in the panel, the display device with three-dimensional sign further including a thick, translucent three-dimensional sign part that is provided in a part of a front surface of the panel and is formed into a shape representing a character, a graphic, or a pattern.

### Advantageous Effects of Invention

The present invention can provide a display device with three-dimensional sign that can achieve both sign visibility and a variety of presentation effects.

### BRIEF DESCRIPTION OF THE DRAWINGS

FIG. 1 is an explanatory diagram of a display device with three-dimensional sign.

FIG. 2 is an explanatory diagram of a three-dimensional sign part.

FIG. 3 is an explanatory diagram for describing a presentation effect of the display device with three-dimensional sign.

FIG. 4 is an explanatory diagram of a display device with three-dimensional sign according to Embodiment 2.

### DESCRIPTION OF EMBODIMENTS

An embodiment of the present invention will be described below with reference to the drawings.

### Embodiment 1

<Display Device with Three-Dimensional Sign>

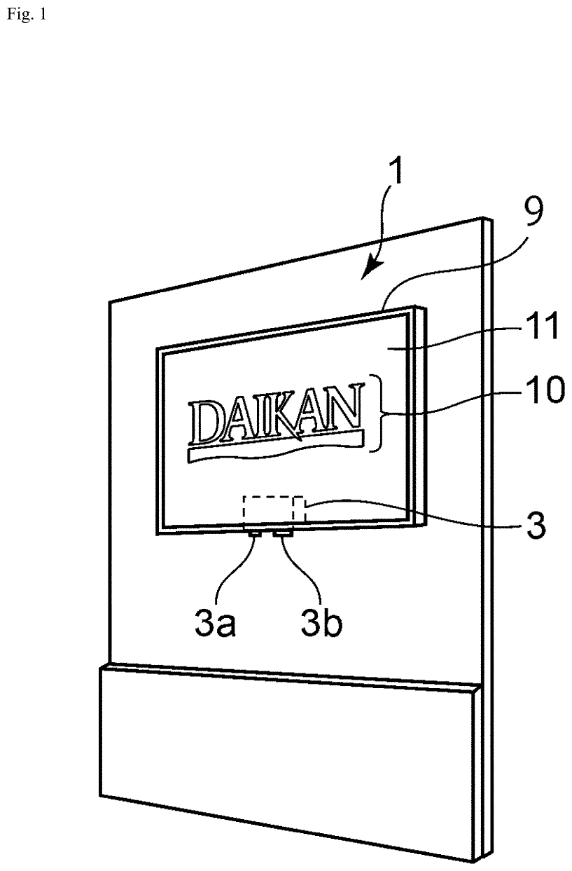

FIG. 1 is an explanatory diagram of a display device with three-dimensional sign 1.

The display device with three-dimensional sign 1 has a thin box shape having a rectangular opening on its front surface, and has a frame 9 on the front surface along four sides. A plate-shaped display panel 11 for displaying an image is fitted into the frame 9. The display device with three-dimensional sign 1 has incorporated therein a control unit 3 that controls display of an image on the display panel 11, and includes a three-dimensional sign part 10 provided in a part of the display panel 11 on the front side. The display device with three-dimensional sign 1 is installed on the front wall of a building such as a store for advertisement so as to catch the attention of passersby. The wall on which the display device with three-dimensional sign 1 is installed is not limited to the front wall of a building. The display device with three-dimensional sign 1 may be installed on an appropriate wall such as an inclined wall or a ceiling wall.

<Display Panel>

The display panel 11 may be a liquid crystal panel, an organic EL panel, etc. In the present embodiment, the display panel 11 is a liquid crystal panel having a transparent panel 11a on its front surface, a backlight 13 on its back surface, and a liquid crystal display layer 11b provided between the transparent panel 11a and the backlight 13. The liquid crystal display layer 11b uses a general liquid crystal display part having a multilayer structure in which a transparent electrode, an alignment film, a liquid crystal layer, an alignment film, a transparent electrode, and an array substrate are sequentially provided from the front surface. The transparent panel 11a has a rectangular flat shape with a constant thickness. In the embodiment, the transparent panel 11a and the display panel 11 are formed to be flat. However, they may have appropriate structures such as having a curved surface with an arc cross section formed by wrapping them around a cylindrical pillar. In that case, the transparent panel 11a is also formed to have a constant thickness.

The display panel 11 preferably has a large screen size of 50 inches or more so that it is easily seen by passersby. The shape of the display panel 11 may be selected according to the shape and pattern of the wall where the display panel 11 is to be installed, the installation space, etc., and the display panel 11 may be of a square type or a wide type. The transparent panel 11a provided on the front surface of the display panel 11 may be preferably a glare panel, because the glare panel more beautifully displays a still image and a moving image. Depending on the surrounding installation environment, non-glare treatment may be applied to the front surface of the transparent panel 11a in order to reduce reflection from the outside. The resolution of the display panel 11 is preferably full HD (1920×1080) or higher, because the display panel 11 having such resolution can smoothly display a still image and a moving image. The response speed of the display panel 11 is preferably 8 ms or less in order to reduce image retention. The contrast ratio of the display panel 11 is preferably 1000:1 or more in order to enhance the sharpness of an image. As a mode for driving the display panel 11, there are an IPS mode, a VA mode, and a TN mode, and the mode for driving the display panel 11 is preferably selected according to the content of an image used for advertisement. For example, when the display panel 11 is often viewed from a diagonally lateral direction, the IPS mode that provides a wide angle of view with high image quality is preferably selected. When the sharpness of an image is intended to be emphasized by presentation effect, the VA mode that can increase a contrast ratio is preferably selected. When a fast response speed is required in a fast-moving image, the TN mode is preferably selected.

<Control Unit>

The control unit 3 includes an operation part 3a and a memory card I/F part 3b in addition to a CPU and an internal memory. The control unit 3 is disposed behind the display panel 11 in the display device with three-dimensional sign 1, and is installed on the lower surface of the display device with three-dimensional sign 1 such that the operation part 3a and the memory card I/F part 3b are exposed. The operation part 3a is provided with a power ON/OFF switch. The memory card I/F part 3b is provided with an I/F (interface) for mounting a memory card (storage medium) such as an SD memory card or a USB memory. When the power of the operation part 3a is turned on, and a removable memory card storing image data and a sequence program of the image data is mounted to the memory card I/F part 3b, the CPU of the control unit 3 automatically retrieves the image data and the sequence program of the image data into the internal memory, and sequentially transmits the image data to the display panel 11 in accordance with the retrieved sequence program of the image data, thereby displaying a still image or a moving image in the display panel 11.

Note that a speaker (not shown) may be further installed and connected to the control unit 3. In that case, audio data and a sequence program of the audio data to be output in synchronization with the sequence of the image data may be additionally stored in the above memory card, by which sound can be output from the speaker in synchronization with the still image or the moving image displayed in the display panel 11.

<Three-Dimensional Sign Part>

The three-dimensional sign part 10 is formed into a shape representing a character, a graphic, or a pattern, and in this example, represents a character “DAIKAN” and a line figure expressing a “wavy shape” below the character.

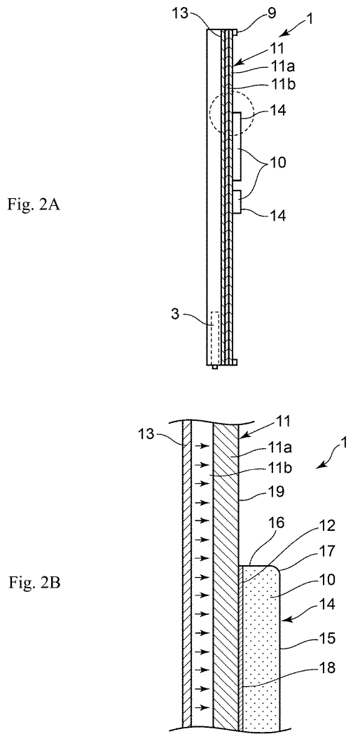

FIG. 2 is an explanatory diagram of the three-dimensional sign part 10.

The three-dimensional sign part 10 is formed of a colorless transparent material. In this example, a colorless transparent acrylic material is used. The upper limit of the thickness of the acrylic material can be 100 mm or less, preferably 50 mm or less, and more preferably 10 mm or less. With this setting, the transparency can be maintained. Further, the lower limit of the thickness of the acrylic material can be 1 mm or more, and more preferably 2 mm or more. With this setting, strength can be maintained. The acrylic material forming the three-dimensional sign part 10 is preferably thicker than the transparent panel 11a. The thickness of the acrylic material is most preferably 2 to 4 mm from the viewpoint of transparency and strength.

The three-dimensional sign part 10 is composed of a plurality of objects 14. Each of the objects 14 is configured to have a constant height which is an amount of protrusion from the transparent panel 11a, and to have a front surface 15 parallel to the front surface 19 of the transparent panel 11a. Further, if the transparent panel 11a is subjected to glare treatment, the front surface 15 is also subjected to glare treatment, and if the transparent panel 11a is subjected to non-glare treatment, the front surface 15 is also subjected to non-glare treatment. Thus, the transparent panel 11a and the three-dimensional sign part 10 have substantially the same transparency, whereby a presentation effect by an image can be satisfactorily viewed.

Note that, when the transparent panel 11a has a flat surface as in the present embodiment, the three-dimensional sign part 10 also has a flat surface, but when the transparent panel 11a has a curved surface such as an arc shape, the three-dimensional sign part 10 is preferably formed to have a similar curved surface. Thus, the height which is an amount of protrusion from the transparent panel 11a can be kept constant.

A peripheral surface 16 of each object 14 is perpendicular to the front surface 19 of the display panel 11 and the front surface 15 of the object 14. If the transparent panel 11a and the front surface 15 are subjected to glare treatment, the peripheral surface 16 is also subjected to glare treatment, and if the transparent panel 11a and the front surface 15 are subjected to non-glare treatment, the peripheral surface 16 is also subjected to non-glare treatment. This can provide a satisfactory presentation effect as a whole. The peripheral surface 16 of each object 14 is not limited to be perpendicular as described above, and may be configured as appropriate. For example, the peripheral surface 16 may be an inclined surface or a curved surface so that the cross-sectional area of the cross section parallel to the front surface 15 decreases as the object 14 protrudes from a connection portion with the display panel 11, or may have a step shape. In this case, from the viewpoint of design property as a sign (signboard) and design property of image display, the inclined surface, the curved surface, or the perpendicular surface that does not have a surface parallel to the front surface 15, unlike a step shape, is preferable, and the perpendicular surface without having inclination is more preferable.

A corner 17 having a right-angled cross section is formed at a connecting portion between the front surface 15 and the peripheral surface 16 of the object 14. The corner 17 may have a non-right angle. For example, the corner 17 may be rounded and curved, or may be chamfered to have a flat surface at a predetermined angle, such as 45 degrees, with respect to the front surface 15. In this case, it is preferable that the corner 17 is perpendicularly formed or rounded without being chamfered for preventing the corner 17 from having a flat surface, and it is more preferable that the corner 17 is perpendicularly formed so as not to reflect light in other directions.

Note that the three-dimensional sign part 10 may partially include portions having different heights or different surface shapes. In that case, the three-dimensional sign part 10 is configured such that the front surface 15 of the object 14 having a predetermined amount or more is at the same height, and similarly shaped corners 17 and peripheral surfaces 16 are formed on the same plane. This can achieve both design property as a sign and design property of image display. The predetermined amount can be set to 50% or more, preferably 70% or more, and more preferably 90% or more.

<Adhesive>

The three-dimensional sign part 10 is joined to the transparent panel 11a by being bonded to the front surface 19 with an adhesive 12. As the adhesive 12, a visible light curing acrylic adhesive is used which contains dichloromethane as a main component and which cures when irradiated with visible light. When the three-dimensional sign part 10 is bonded, first, the adhesive 12 is applied thinly (1 mm or less) on the entire back surface 18 of the three-dimensional sign part 10 without any gap. Next, the back surface 18 of the three-dimensional sign part 10 on which the adhesive 12 is applied is pressed against a predetermined position of the front surface 19 of the transparent panel 11a, and then, visible light is radiated from the front surface 15 side of the three-dimensional sign part 10. The radiated visible light passes through the three-dimensional sign part 10 and then reaches the adhesive 12 to cure the adhesive 12.

In this way, the three-dimensional sign part 10 can be accurately and easily bonded to a predetermined position of the front surface 19 of the transparent panel 11a. Further, since the three-dimensional sign part 10 is formed of an acrylic material, it has high transmittance of visible light. Therefore, the adhesive 12 can be quickly cured and tightly bonded. Furthermore, the adhesive 12 that is cured and bonded is colorless and transparent, and has high light transmittance. Therefore, even when a portion of light that is emitted from the backlight 13 behind the display panel 11 and radiated from the front surface 19 of the display panel 11 reaches the adhesive 12 between the front surface 19 of the display panel 11 and the back surface 18 of the three-dimensional sign part 10, reflection or scattering is less likely to occur in the adhesive 12 having high light transmittance.

Further, the surfaces of the three-dimensional sign part 10 and the transparent panel 11a which face each other are bonded to each other without any gap so that there are no air bubbles and gaps. This allows a person to satisfactorily view an image displayed in the display panel 11 without being disturbed by air bubbles or the like. At least 80% or more of a portion between the three-dimensional sign part 10 and the transparent panel 11a is filled with the adhesive 12 with a gap being less than 20%.

Preferably, 90% or more of the portion is filled with the adhesive with a gap being less than 10%, and more preferably, 95% or more of the portion is filled with the adhesive 12 with a gap being less than 5%.

A plurality of grooves may be formed in advance in the back surface 18 of the three-dimensional sign part 10. In this case, when the back surface 18 of the three-dimensional sign part 10 to which the adhesive 12 is applied is pressed against the predetermined position of the front surface 19 of the display panel 11 during bonding of the three-dimensional sign part 10, the adhesive 12 easily flows along the grooves in the back surface 18 of the three-dimensional sign part 10. Thus, air bubbles are less likely to be entrained in the adhesive 12. Accordingly, even when a large object 14 having a large bonding area on the back surface 18 is used, smooth bonding surface without having entrained air bubbles can be formed.

Further, the transparent panel 11a and the three-dimensional sign part 10 may be connected such that they are integrally formed using the same material by an appropriate method such as cutting from a thick transparent plate or die cutting using a mold. In that case, it is also preferable that the transparent panel 11a has a flat shape with a constant thickness, and most of (the abovementioned predetermined amount) the three-dimensional sign part 10 also has a flat shape protruding to the front surface from the transparent panel 11a with a constant height.

<Presentation Effect of Advertisement>

A removable memory card that stores image data including a still image and/or a moving image according to the three-dimensional shape of the three-dimensional sign part 10 and a sequence program of the image data is prepared in advance. After the power of the operation part 3a of the control unit 3 is turned on, the prepared memory card is mounted to the memory card I/F part 3b. When the control unit 3 recognizes that the memory card is mounted, the CPU of the control unit 3 automatically retrieves the image data and the sequence program of the image data into the internal memory, and sequentially transmits the image data to the display panel 11 in accordance with the sequence program of the retrieved image data, thereby displaying the still image or the moving image in the display panel 11.

Here, a variety of presentation effects are provided to the still image and the moving image to be displayed for advertisement.

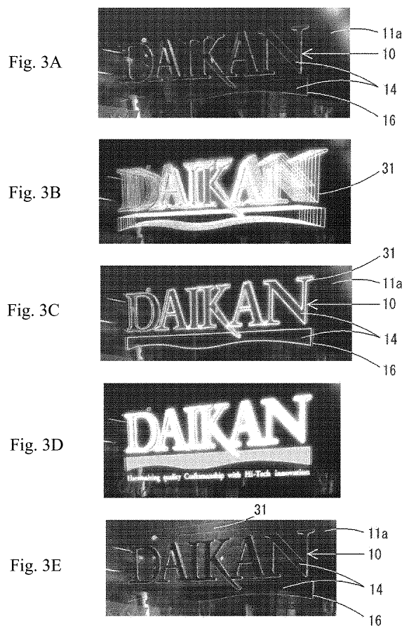

FIG. 3 is an explanatory diagram for describing an example of the presentation effect using monochrome photographs.

As shown in FIG. 3(A), when the three-dimensional sign part 10 and the display panel 11 of the transparent panel 11a have a black display (turned off), the peripheral surfaces 16 of the objects 14 constituting the three-dimensional sign part 10 look as if they emit pale white light due to ambient light depending on the viewing angle, etc. Therefore, although not clear, it is visually recognized that the three-dimensional sign part 10 exists as a three-dimensional sign.

Here, as shown in FIG. 3(B), when an image 31 that does not completely match the shape of the three-dimensional sign part 10 is displayed in the display panel 11, such a presentation effect can be provided that a portion of the image 31 along the shape of the three-dimensional sign part 10 appears three-dimensional, and the other portions are displayed without disturbing the shape of the three-dimensional sign part 10. In the example of FIG. 3(B), the image 31 is displayed such that the edge (peripheral surface 16) of the three-dimensional sign part 10 linearly spreads outward in many layers, and the innermost (smallest) linear shape coincides with the edge (peripheral surface 16) of the three-dimensional sign part 10. The other portions are turned off and have a black display. This displaying state of the image 31 is a presentation transition mode during transition from a three-dimensional sign shape-independent presentation mode in which the image different from the shape of the three-dimensional sign part 10 is displayed to a three-dimensional sign shape-emphasis presentation mode in which the image matching the shape of the three-dimensional sign part 10 is displayed.

When the linear image in many layers shown in FIG. 3(B) is converged, and the image 31 conforming to the edge (peripheral surface 16) of the three-dimensional sign part 10 is displayed as shown in FIG. 3(C), the resultant image is visible as a three-dimensional sign that is linearly glowing, unlike a display that simply displays a linear image, due to the synergistic effect of the edge (peripheral surface 16) of the three-dimensional sign part 10 and the image 31.

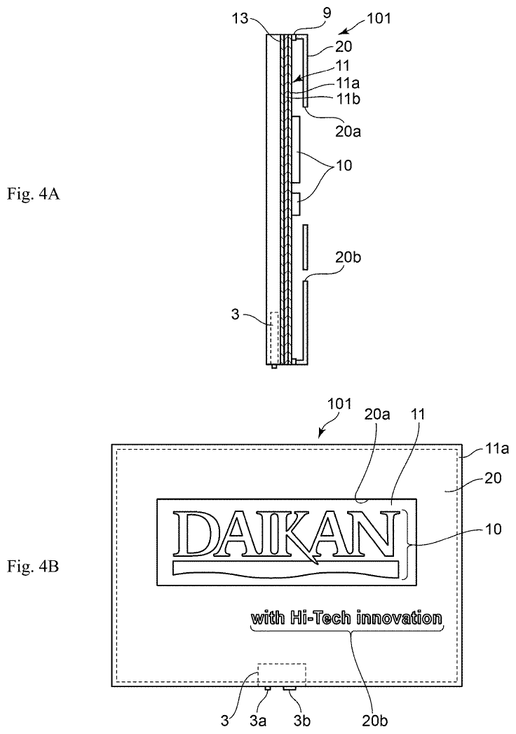

FIG. 4(D) shows an example of displaying an image 31 in which a luminous part having the same shape (character of DAIKAN and wavy line beneath) as the shape of the three-dimensional sign part 10 and characters which are displayed below the luminous part and which are smaller in size than the character of the three-dimensional sign part 10 are glowing. In this case, the character of the three-dimensional sign part 10 appears large and three-dimensional, and the characters of “Harmonizing quality Craftmanship with Hi-Tech innovation” having a size 1/20 or less the size of the character of the three-dimensional sign part 10 are clearly visible. That is, although not appearing three-dimensionally due to the absence of the three-dimensional sign part 10, the smaller characters are clearly visible without being blurred around the edges. This displaying state of the image 31 shown in FIG. 4(D) is the three-dimensional sign shape-emphasis presentation mode for emphasizing the three-dimensional sign part 10.

Further, as shown in FIG. 4(E), when the three-dimensional sign part 10 is not illuminated and kept black (turned off), and the image 31 is displayed in the other portions (transparent panel 11a), the three-dimensional sign part 10 appears three-dimensionally due to the edge (peripheral surface 16) of the three-dimensional sign part 10, despite the three-dimensional sign part 10 being black and dark. Therefore, in this case, the three-dimensional sign part 10 can function as a clear sign.

In addition, the following presentation effects can be performed. For example, the object 14 having a “wavy shape” in the three-dimensional sign part 10 is regarded as a horizontally-long transparent glass, a variety of cobalt-blue patterns, like liquids, having different sizes move down along the edge of each of the objects 14 of the letters of “DAIKAN” above the “wavy shape”, and the patterns which are moving down are put into the transparent glass. Alternatively, such a presentation effect is performed as if an animal is gradually transformed into the letters of “D”, “A”, “I”, “K”, “A”, and “N” of the three-dimensional sign part 10 from “D” to “A”, while gradually moving from the position of “D” to the position of “A”. Alternatively, the character “DAIKAN” is written in a single stroke along the edge of each object 14 of the letters of “DAIKAN” from four directions, that is, up, down, left, and right, of the frame 9. Due to various effects provided to still images and moving images to be displayed in the display panel 11 as described above, the edge of each object 14 of the three-dimensional sign part 10 is particularly emphasized, whereby the three-dimensional sign part 10 attracts attention. Then, the display of the three-dimensional sign part 10 leaves strong impression on passersby, and therefore, advertising effects are improved. Here, since the corner 17 at the edge of the object 14 has the shape described above, light emitted from the corner 17 is mild, and creates a high-quality mood. Therefore, the “DAIKAN” displayed by the three-dimensional sign part 10 can also create a high-quality mood. Further, an image 31 having a strong contrast with a clear pattern or design, which is unrelated to the shape of the three-dimensional sign part 10, may be displayed in the display panel 11. For example, a large number of mandarin oranges may be displayed as the image 31. In this case, the three-dimensional sign part 10 is not conspicuous due to the image 31 having strong contrast, and the display is presented as the three-dimensional sign shape-independent presentation mode unrelated to the shape of the three-dimensional sign part 10.

With the above configuration and operation, the thick, translucent three-dimensional sign part 10 formed into a shape representing a character, a graphic, or a pattern is partially provided on the front surface 19 side of the display panel 11. A person seeing the display panel 11 provided with the three-dimensional sign part 10 presumes that not general news information or entertainment information but information regarding the character, etc. formed on the three-dimensional sign part 10, that is, “DAIKAN”, is displayed in the display panel 11, and cannot help looking at the display panel 11, wondering what kind of information regarding “DAIKAN” will be displayed.

The three-dimensional sign part 10 is made of a colorless transparent material and is bonded to the front surface 19 of the display panel 10 with the colorless transparent adhesive 12. Therefore, light emitted from the display panel 10 immediately under the portion where the three-dimensional sign part 10 is bonded is radiated through the three-dimensional sign part 10 with little attenuation. Thus, the outer shape of the three-dimensional sign part 10 is clearly visible. In addition, the abovementioned presentation effect of an image for bringing attention on the edge of each object 14 of the three-dimensional sign part 10 can give, to a viewer, a strong impression of the three-dimensional sign part 10, here, the character “DAIKAN”. Furthermore, performing a plurality of types of presentation effects having different tastes holds the viewer's attention, and can prompt the viewer to just watch once he/she views the display.

The corner 17 of the edge of each object 14 of the three-dimensional sign part 10 is designed in shape, such as rounded, as described above. Therefore, light emitted from the three-dimensional sign part 10 is not sharp, but gentle and soft. Thus, if, for example, the character “DAIKAN” in the three-dimensional sign part 10 represents a brand name, it is possible to give a viewer an elegant and high-class image on the brand “DAIKAN”.

Further, when, for example, the display device is used in a restaurant, a menu can be displayed on the portion of the transparent panel 11a where the three-dimensional sign part 10 is not provided. In this case, a function of providing a sign as the three-dimensional sign part 10 and a function of displaying a menu can be both achieved. Further, the display of the menu can be changed as appropriate. For example, the menu to be displayed may be changed between at lunchtime and at dinnertime, or the menu to be displayed may be changed on the day of the week. As a result, the display device with three-dimensional sign can be used as an extremely convenient display device for displaying sign and information.

Further, the objects 14 of the three-dimensional sign part 10 are not necessarily flat with the same height, and a three-dimensional object which is partially different may be used as the objects 14. For example, such an object 14 may be added which has a shape of a glass seen from side with its center protruding most in the horizontal direction. In this case, the glass-shaped object 14 appears three-dimensionally, and further, when an image 31 indicating that wine is poured out into the glass-shaped object 14 is displayed as a moving image, the presentation effect indicating as if the wine is really poured out into the glass can be provided.

As described above, unlike the case where an image is simply displayed in the display, it is possible to achieve both a three-dimensional and attractive presentation effect using the three-dimensional sign part 10 and improvement in sign visibility.

### Embodiment 2

<Display Device with Three-Dimensional Sign According to Embodiment 2>

FIG. 4 is an explanatory diagram of a display device with three-dimensional sign 101 according to Embodiment 2. In the following, only the differences from Embodiment 1 will be described, and the same parts will be denoted by the same reference numerals.

<Decorative Panel>

A decorative panel 20 is provided so as to cover the front surface 19 side of the display panel 11. The decorative panel 20 is a rectangular plate having a thickness of several millimeters, has a width enough to cover the display panel 11 and the frame 9, is parallel to the display panel 11, and is located at a little distance from the display panel 11. The outer peripheral part is fixed to the frame 9. The decorative panel 20 is opaque and is made of, for example, a stainless material or a material coated with noble metal. The decorative panel 20 may have a matte surface in order to suppress a gloss, or may have a mirror-finished surface in order to provide a gloss.

The decorative panel 20 has a display window 20a that is opened in a region facing the three-dimensional sign part 10 provided on the display panel 11 and the vicinity of the region. The display window 20a is a rectangular opening here. In a front view, the character “DAIKAN” in the three-dimensional sign part 10 and the graphic representing a “wavy shape” are visible through the display window 20a together with a part of the display panel 11 behind. That is, the three-dimensional sign part 10 and its vicinity are within the display window 20a so that they can be viewed in a concentrated manner.

The decorative panel 20 is formed with a designed opening 20b which is opened in a shape representing a character, a graphic, or a pattern. Here, the designed opening 20b is formed by punching out the shape of the character “with Hi-Tech innovation” in the diagonally lower right region of the decorative panel 20. The designed opening 20b is not limited to be formed in the diagonally lower right region of the decorative panel 20, and may be formed at any position. Thus, by changing the color, pattern, or the like of light emitted by the display panel 11 located behind and facing the designed opening 20b, the color, pattern, or the like behind the designed opening 20b can be changed.

With the configuration and operation described above, the display device with three-dimensional sign 101 does not look like a mere commercially-available display or monitor due to the decorative panel 20, and this can prevent a viewer from having a preconception that general news information or entertainment information irrelevant to advertisement is displayed.

Further, since the decorative panel 20 is formed of a stainless material or a material coated with noble metal, it is possible to give the viewer an impression of high quality.

The decorative panel 20 has the opening of the display window 20a. This configuration enables the viewer to view the three-dimensional sign part 10 and its vicinity through the display window 20a in a concentrated manner. Thus, advertising effect is improved.

The designed opening 20b formed by punching out the decorative panel 20 can change the color, pattern, etc. behind the designed opening 20b, whereby a presentation effect having a different taste from that of the presentation effect for the three-dimensional sign part 10 on the display panel 11 can be provided.

### INDUSTRIAL APPLICABILITY

The present invention can be used in the industry of illuminated signs and illuminated advertisements for store names and logos.

### REFERENCE SIGNS LIST

1, 101: Display device with three-dimensional sign
3: Control unit
3a: Operation part
3b: Memory card I/F part
9: Frame
10: Three-dimensional sign part
11: Display panel
12: Adhesive
13: Backlight
14: Object
17: Corner
20: Decorative panel
20a: Display window
20b: Designed opening

1. A display device with three-dimensional sign comprising:
a display panel that has a transparent panel on a front surface and that displays an image including a still image and/or a moving image; and
a control unit that controls display of the image in the display panel,
the display device further including a three-dimensional sign part that is thick and translucent and is provided in a part of a front surface of the transparent panel, the three-dimensional sign part being formed into a shape representing a character, a graphic, or a pattern.

2. The display device with three-dimensional sign according to claim 1, wherein the three-dimensional sign part is formed of a colorless transparent material, and 80% or more of a surface of the three-dimensional sign part facing the front surface of the transparent panel is joined to the transparent panel.

3. The display device with three-dimensional sign according to claim 1, wherein 50% or more of the three-dimensional sign part protrudes from the front surface of the transparent panel with a constant amount of protrusion, and has a surface parallel to the front surface of the transparent panel.

4. The display device with three-dimensional sign according to claim 3, wherein the three-dimensional sign part has a peripheral surface around the surface, and the peripheral surface, the surface of the three-dimensional sign part, and the front surface of the transparent panel are all formed to be glare or non-glare.

5. The display device with three-dimensional sign according to claim 1, further comprising a decorative panel that is opaque, has a plate shape, and covers a front surface side of the display panel,
wherein the decorative panel has a display window opened in a region facing the three-dimensional sign part and in a vicinity of the region.

6. The display device with three-dimensional sign according to claim 5, wherein the decorative panel is formed with a designed opening that is opened in a shape representing a character, a graphic, or a pattern.

7. The display device with three-dimensional sign according to claim 1, wherein the control unit includes a CPU, an internal memory, an operation part, and a memory card I/F part, the control unit being mounted with a removable storage medium that stores image data and controlling display of the image in the display panel.
